(19) United States
(12) Patent Application Publication
(10) Pub. No.: US 2020/0368638 A1
(43) Pub. Date: Nov. 26, 2020

(54) SYSTEM AND METHOD FOR SEPARATING COMPONENTS FROM HIGH PRESSURE CO2

(71) Applicant: Michael J. O'Brien, North Chesterfield, VA (US)

(72) Inventor: Michael J. O'Brien, North Chesterfield, VA (US)

(21) Appl. No.: 16/880,381

(22) Filed: May 21, 2020

Related U.S. Application Data
(60) Provisional application No. 62/850,873, filed on May 21, 2019.

(51) Int. Cl. B01D 11/02; B01D 53/00; B01D 19/00

(52) U.S. Cl. CPC B01D 11/0296; B01D 53/002; B01D 2011/007; B01D 19/0063; B01D 11/0203; B01D 19/0036

(57) ABSTRACT

A system for separating a solute from high pressure CO2 is provided. The system includes a flash tank receiving a medium pressure rich solvent stream of CO2. In the flash tank, droplets of the medium pressure rich solvent stream of CO2 fall downwardly and accumulate to form a solvent liquid. A heating system is submerged in the solvent liquid and causes the solvent liquid to boil, which releases gaseous CO2 and results in a solute precipitating to the bottom of the flash tank. A liquid level transmitter monitors the level of the solvent liquid and controls the heating system to keep the liquid level above the heating system. The precipitated solute is extracted from the flash tank through a solute egress located at the bottom of the flash tank and controlled by a solute valve.

### CROSS-REFERENCE TO RELATED APPLICATIONS

The present application claims the benefit of U.S. Provisional Application No. 62/850,873, filed May 21, 2019, entitled “System and Method for Separating Components from High Pressure CO2” which is hereby incorporated by reference in its entirety.

### BACKGROUND OF THE INVENTION

The present invention generally relates to a system for separating components from high pressure CO2. More particularly, the present invention relates a process control system including one or more flash tanks having heating elements that cause components to precipitate from high pressure CO2.

High pressure dense gas or supercritical extraction or separation processes result in a solute discharge stream with components or chemicals that are dissolved in the solvent or dense gas. One way to separate and recover the solute components is by reducing the pressure of the high-pressure dense gas or supercritical fluid. This pressure reduction is accomplished by providing a reduction in pipe diameter like an orifice plate, or a long section of smaller diameter pipe with sufficient drag forces to reduce the pressure, or a control valve or multiple control valves, which may be designed for the pressures and fluid properties to provide a particular flow rate range and a lower pressure range downstream. In some systems, this pressure reduction, to below the critical point, reduces the solubility of the components, causing them to condense or precipitate out of solution. The pressure reduction may result in all vapor if the stream is hot enough before the pressure reduction. Alternately, in some embodiments, the pressure reduction may result in part vapor and part liquid.

### BRIEF SUMMARY OF THE INVENTION

One or more of the embodiments of the present invention provide a system and method for extracting an organic oil such as Cannabidiol (CBD), Tetrahydrocannabinol (THC), or both from a high pressure CO2 solvent. As further described below, high pressure CO2 is introduced to an extractor and then the result is introduced into a flash tank as a medium pressure rich solvent stream of CO2. In the flash tank, droplets of the medium pressure rich solvent stream of CO2 fall downwardly and accumulate to form a solvent liquid. A steam coil is submerged in the solvent liquid and causes the solvent liquid to boil, which releases gaseous CO2 and results in a solute precipitating to the bottom of the flash tank. A liquid level transmitter monitors the level of the solvent liquid and controls the steam coil to keep the liquid level above the heating system. The precipitated solute is extracted from the flash tank through a solute egress located at the bottom of the flash tank. Additionally, an output from the first flash tank may be introduced into a second flash tank where the process above may be repeated.

### BRIEF DESCRIPTION OF THE DRAWINGS

FIG. 1 illustrates one embodiment of a system for separating components from high pressure CO2 according to an embodiment of the present invention.

FIG. 2 illustrates in greater detail an embodiment of the present invention for use in extracting Cannabidiol (CBD), Tetrahydrocannabinol (THC), or both.

### DETAILED DESCRIPTION OF THE INVENTION

In one embodiment of the invention, the solvent gas and the liquid, along with the solute, may be sent to a Flash Tank for separation. The Flash Tank vessel may be designed by one normally skilled in the art to provide sufficient height and diameter to allow disengagement of the liquid precipitate from the vapor by using gravity. At sufficiently low gas velocities in the upper portion of the flash tank, set by the relationship between the overall gas flow rate and the tank diameter, the higher density liquid droplets will fall due to gravity instead of being carried upward as they would if the vapor velocity were too high.

In the case of supercritical CO2, at the most desirable extraction conditions, from 75-600 atmospheres, more preferably from 90-500 atmosphere, more preferably from 200 to 400 atmospheres, more preferably from 250-350 atmospheres and between 10-105° C., more preferably between 30 and 60° C., the pressure reduction for the feed to the Flash Tank results in a two-phase stream, both liquid and vapor CO2. The CO2 vapor in this case would have separated from most or all of the chemical components, but the CO2 liquid would still contain a significant amount of the dissolved component, due to a higher solubility of that component in the liquid than the vapor.

As further described below, one or more embodiments of the invention may employ a heater coil (for example, pipes with a heating medium such as hot water or steam) in the lower portion of the flash tank vessel. This heater coil eliminates the need to heat the entire stream of supercritical fluid rich CO2. Instead, the fraction of the stream that is not vaporized, now liquid CO2, will be vaporized by the heater coil. The fraction of the stream that is not vaporized would range from 10 to 95%, depending on extraction temperature and pressure, and the flash tank pressure.

Initially at startup, the CO2 is allowed to build up to a desirable level above the heater coil. Then the heater coil is activated to continuously vaporize the incoming CO2. At that point the rate of steam or hot water is regulated to control the liquid level in the flash tank.

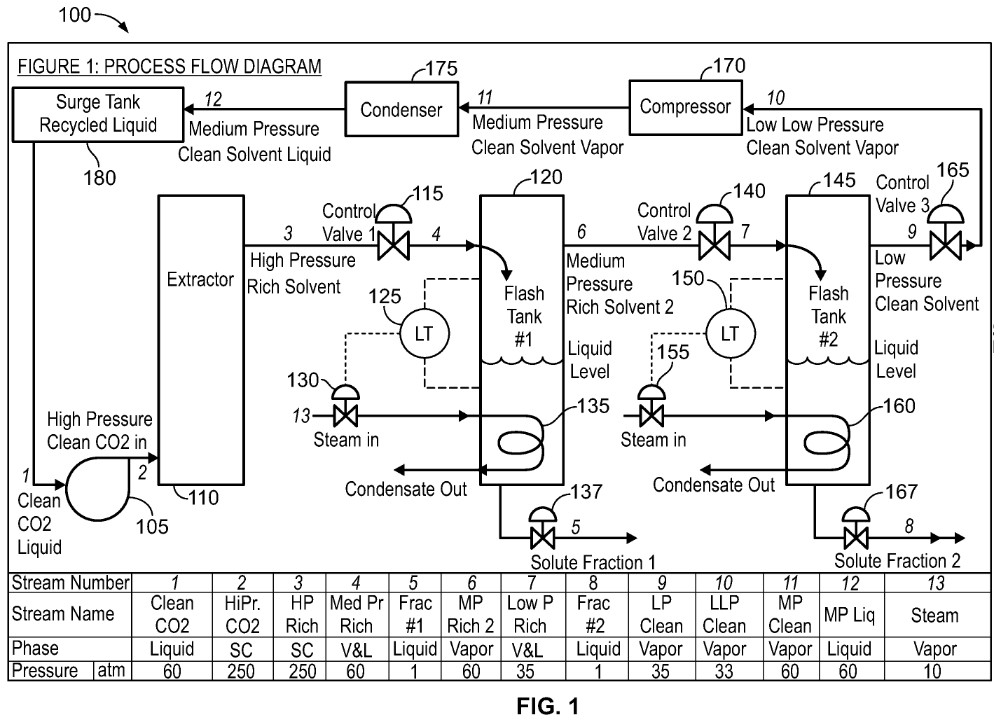

In one embodiment of the invention the heating medium is used to control the level in the flash tank. In this regard, 1 suitable level transmitter (LT in FIG. 1) is used to measure the liquid level. The amount of hot water, steam, or heating medium is regulated to evaporate sufficient CO2 such that the liquid level is maintained in the desired range. The desired range for the liquid level is above the heater coil, leaving adequate space in the flash tank above for disengagement of the liquid precipitate from the vapor phase of the entering CO2. For example, the heating coil may be fully submerged in the liquid—or may alternatively be partially submerged.

One or more of the features described herein allow the extraction conditions to be optimized for extraction, without compromising the conditions to avoid liquid in the flash tank. The alternatives include using less desirable higher temperature extraction conditions (above 90° C.) so that only CO2 vapor and no liquid is formed in the Flash Tank. This is less desirable for two reasons: the sensitivity of thermally labile components to high temperatures, and the reduced solubility of the oil and thus reduced extraction capability at high temperature relative to low temperature at the same pressure.

Another alternative method is to pre-heat the supercritical CO2 before the control valve, or to heat the CO2 vapor/liquid stream downstream of the control valve, as seen in many commercially available extraction systems. These both have the disadvantage of heating the whole stream, which is composed of some or all gas, instead of the preferred embodiment of this invention, which is only heating liquid, and only heating part of the stream, not the entire stream.

By heating after the pressure reduction, the present system allows partial vaporization of the solvent, and heating only the fraction of solvent necessary to boil.

By heating after the pressure reduction for CO2, the present system allows boiling at near ambient temperature (15-30° C.) instead of heating the solvent to elevated temperatures in the range above 90° C.

By adding only enough heat to boil the liquid fraction, the present system results in substantial energy savings compared to the current state of the art. Typically, the entire Stream 3 (as shown in FIG. 1) is heated to a temperature of about 105° C. to prevent any liquid in the flash tank. Or, the same stream is heated downstream of the control valve, before the flash tank. At extraction conditions of 37° C. and 300 atmospheres, the heat required to reach 105° C. is 37 kcal/kg, which is quite large. Thus, one advantage of the present system is the ability to add only enough heat to boil the liquid fraction. For example, if the pressure downstream of Control Valve 1 and in Flash Tank 1 is 40 atmospheres, the result is 21% vapor and 79% liquid. The heat required to boil the liquid stream at those conditions is only 22 kcal/kg, a 40% energy reduction, without even taking into account the fact that only 79% of the stream needs to be heated (79% of the kilograms in the original stream).

In one embodiment, the Heater coil is external to the Flash Tank, with piping from below the liquid level in the Flash Tank. The vapor stream from the boiler would be returned to the upper (Vapor) portion of the Flash Tank.

FIG. 1 illustrates one embodiment of a system 100 for separating components from high pressure CO2 according to an embodiment of the present invention.

FIG. 1 includes 1 pressurizing system 105, an extractor 110, a first CO2 control valve 115, a first flash tank 120, a first tank level transmitter 125, a first tank steam control valve 130, a first tank steam coil 135, a first tank solute valve 137, a second CO2 control valve 140, a second flash tank 145, a second tank level transmitter 150, a second tank steam control valve 155, a second tank steam coil 160, a second tank solute valve 167, a third CO2 control valve 165, a compressor 170, a condenser 175, and a recycled liquid surge tank 180.

Additionally, FIG. 1 identifies 13 stream components shown in the system of FIG. 1 including the stream number, stream name, phase, and pressure. Each stream component is shown in Table 1 below:

TABLE 1

| Stream | Stream | | Pressure |
|---|---|---|---|
| Number | Name | Phase | (atm) |
| 1 | Clean CO2 Liquid | Liquid | 60 |
| 2 | High Pressure Clean CO2 | Supercritical | 250 |
| 3 | High Pressure Rich Solvent | Supercritical | 250 |
| 4 | Medium Pressure Rich Solvent | Vapor and Liquid | 60 |
| 5 | Solute Fraction #1 | Liquid | 1 |
| 6 | Medium Pressure Rich Solvent | Vapor | 60 |
| 7 | Low Pressure Rich Solvent | Vapor and Liquid | 35 |
| 8 | Solute Fraction #2 | Liquid | 1 |
| 9 | Low Pressure Clean Solvent | Vapor | 35 |
| 10 | Low Low Pressure Clean | Vapor | 33 |
| | Solvent Vapor | | |
| 11 | Medium Pressure Clean | Vapor | 60 |
| | Solvent Vapor | | |
| 12 | Medium Pressure Clean | Liquid | 60 |
| | Solvent Liquid | | |
| 13 | Steam | Vapor | 10 |

As shown in FIG. 1, clean CO2 liquid passes from the recycled liquid surge tank 180 to the pressurizing system 105. The pressurizing system pressurizes the CO2 liquid to 250 atm and passes it to the extractor 110 as high pressure clean CO2. At the extractor 110, a solute material is transferred from a feed phase into the CO2 solvent. This forms the high pressure rich solvent, which is maintained at a pressure of 250 atm. The high pressure rich solvent then passes to the first control valve 115.

The first control valve 115 reduces the pressure to form the medium pressure rich solvent, which then enters the first flash tank 120. In the first flash tank 120, the inlet flow rate is controlled by the first control valve 115, and the pressure is controlled by the second control valve 140. In the first flash tank 120, CO2 vapor from the medium pressure rich solvent stream continuously flows into and out of the top of the tank, toward the lower pressure downstream of the second control valve 140. The medium pressure rich solvent that exits the first flash tank 120 has a lower solute concentration than the medium pressure rich solvent that enters the first flash tank because some of the solute precipitates out of the solvent downstream of the first CO2 control valve 115 and in the first flash tank 120. The solute exits the first flash tank 120 as Solute Fraction #1 under the control of the first tank solute valve 137.

In operation, the liquid fraction in the medium pressure rich solvent falls by gravity and density difference to the bottom of the first flash tank 120. The liquid solvent is allowed to build up to a level above the first tank steam coil 135. The liquid level is measured and indicated by the first tank level transmitter 125, shown as LT in FIG. 1. Many types of commercially available liquid level measurement systems may be used, including capacitance, radar, ultrasonic, and X-ray level measurement devices. Because of the high static pressure in this application, a type of level transmitter known as a “Delta P,” or “differential pressure” may be employed. It measures two pressures, above and below the entire liquid zone, as shown in FIG. 1. The difference indicates the level, using a calibration for the liquid density vs the dense gas. If there was no liquid, the two pressures would be nearly equal; as the liquid builds up, only the bottom measurement rises. Other measurement devices may employ only a single lead.

The first tank level transmitter 125 operates as a control system for the first tank steam control valve 130, as shown by the dotted lines in FIG. 1. The first tank steam control valve 130 regulates the introduction of steam to the first tank steam coil 135 in order to boil the liquid CO2. Other heating systems may also be employed. Alternatively, hot water or another heating medium or another heating system may be used for boiling. The steam rate or hot water rate is modulated manually or automatically by a control system to maintain the liquid level above the steam coil. Inside the first flash tank 120, and at steady-state conditions, the steam or hot water rate are preferably constant. If the liquid level rises above the desired set-point, more steam or hot water is used to increase the boiling rate, and reduce the liquid level. Similarly, if the liquid level is below the desired set point, less steam or hot water is used to reduce boiling and allow the liquid level to rise to the set-point. The range is selected above the heater coil and below the liquid-vapor disengagement zone of the flash tank. The concentration of the solute is allowed to build to the saturation level in the solvent CO2, and as more rich solvent enters the first flash tank 120, the additional dissolved solute precipitates out as liquid. In the preferred application for oil extraction, the density of the oil is greater than liquid CO2, and thus the oil drops via gravity to the bottom of the first flash tank 120.

A suitable level measurement device, any number of which are commercially available (such as capacitance, radar, ultrasonic, and X-ray level measurement devices), is used to maintain a liquid oil level below the CO2. The first tank solute valve 137 then regulates the follow of the first tank solute fraction oil out of an egress, outflow, aperture, or port in the first flash tank 120 and maintains the level of oil in the first tank to prevent CO2 from escaping into the solute fraction #1 stream.

Returning to the medium pressure rich solvent stream that exits the first flash tank, the solvent stream is then regulated by the second CO2 control valve 140 which results in the low pressure rich solvent. The low pressure rich solvent then passes into the second flash tank.

Similarly to the first flash tank 120, in the second flash tank 120, the inlet flow rate is controlled by the second CO2 control valve 140, and the pressure is controlled by the third CO2 control valve 165. In the second flash tank 145, CO2 vapor from the low pressure rich solvent stream continuously flows into and out of the top of the tank, toward the lower pressure downstream of the third control valve 165. The low pressure rich solvent that exits the second flash tank 145 has a lower solute concentration than the low pressure rich solvent that enters the second flash tank because some of the solute precipitates out of the solvent downstream of the second control valve 140 and in the second flash tank 145. The solute exits the second flash tank 145 as Solute Fraction #2 under the control of the second tank solute valve 167.

In operation, similarly to the first flash tank 120, the liquid fraction in the low pressure rich solvent falls by gravity and density difference to the bottom of the second flash tank 145. The liquid solvent is allowed to build up to a level above the second tank steam coil 160. The liquid level is measured and indicated by the second tank level transmitter 150, shown as LT in FIG. 1. Again, many types of commercially available liquid level measurement systems may be used, including capacitance, radar, ultrasonic, and X-ray level measurement devices. Because of the high static pressure in this application, a type of level transmitter known as a “Delta P,” or “differential pressure” may be employed. It measures two pressures, above and below the entire liquid zone, as shown in FIG. 1. The difference indicates the level, using a calibration for the liquid density vs the dense gas. If there was no liquid, the two pressures would be nearly equal; as the liquid builds up, only the bottom measurement rises. Other measurement devices may employ only a single lead.

The second tank level transmitter 150 operates as a control system for the second tank steam control valve 155, as shown by the dotted lines in FIG. 1. The second tank steam control valve 155 regulates the introduction of steam to the second tank steam coil 135 in order to boil the liquid CO2. Alternatively, hot water or other heating medium may be used for boiling. The steam or hot water rate is modulated in a similar manner to the heating medium in Flash Tank 120 to maintain the liquid level above the steam coil at a pre-determined set-point inside the second flash tank 145 similar to as described above with regard to the first flash tank. The concentration of the solute is allowed to build to the saturation level in the solvent CO2, and as more rich solvent enters the second flash tank 145, the additional dissolved solute precipitates out as liquid. In the preferred application for oil extraction, the density of the oil is greater than liquid CO2, and thus the oil drops via gravity to the bottom of the second flash tank 145.

A suitable level measurement device, any number of which are commercially available (such as capacitance, radar, ultrasonic, and X-ray level measurement devices), is used to maintain a liquid oil level below the CO2. The second tank solute valve 167 then regulates the follow of the second tank solute fraction oil out of the second flash tank 145 and maintains the level of oil in the second tank to prevent CO2 from escaping into the solute fraction #2 stream.

Returning to the low pressure clean solvent stream that exits the second flash tank 145, the solvent stream is then regulated by the third control valve 165 which results in the low low pressure clean solvent vapor. The low low pressure clean solvent vapor then passes to the compressor 170, which pressurizes it from preferably 33 atm to 60 atm to form the medium pressure clean vapor solvent. The medium pressure clean vapor solvent then passes to the condenser 175 which condenses the medium pressure clean vapor solvent to form the medium pressure clean vapor liquid. The medium pressure clean vapor liquid is then passed to the recycled liquid surge tank 180 where is it available for future use.

In one embodiment, the high pressure rich solvent in stream 3, may be in the range of 100-400 bar, and may then pass through a pressure reduction device to a pressure below 72.8 atm, which may be a critical pressure, and the resultant stream 4 of medium pressure rich solvent, is sent to the flash tank. Depending on the initial extraction temperature and pressure in stream 3, stream 4 may be more than 80% liquid. In one or more embodiment, at extraction conditions above 150 atm, the extraction temperature is 90° C. or greater to avoid any liquid in the 60 atm flash tank. A more desirable set of extraction conditions for higher oil solubility includes pressures greater than 200 atmosphere and as high as 500 atm, and temperatures below 50° C. At the most desirable extraction conditions, without heating the solvent before depressurization results in 15-95% liquid.

Although FIG. 1 illustrates an embodiment with one extractor 110, multiple extractors may be piped together in series. Further, although FIG. 1 illustrates an embodiment with two flash tanks in series, alternative embodiments, including a single flash tank and three or more than two flash tanks in series may be employed.

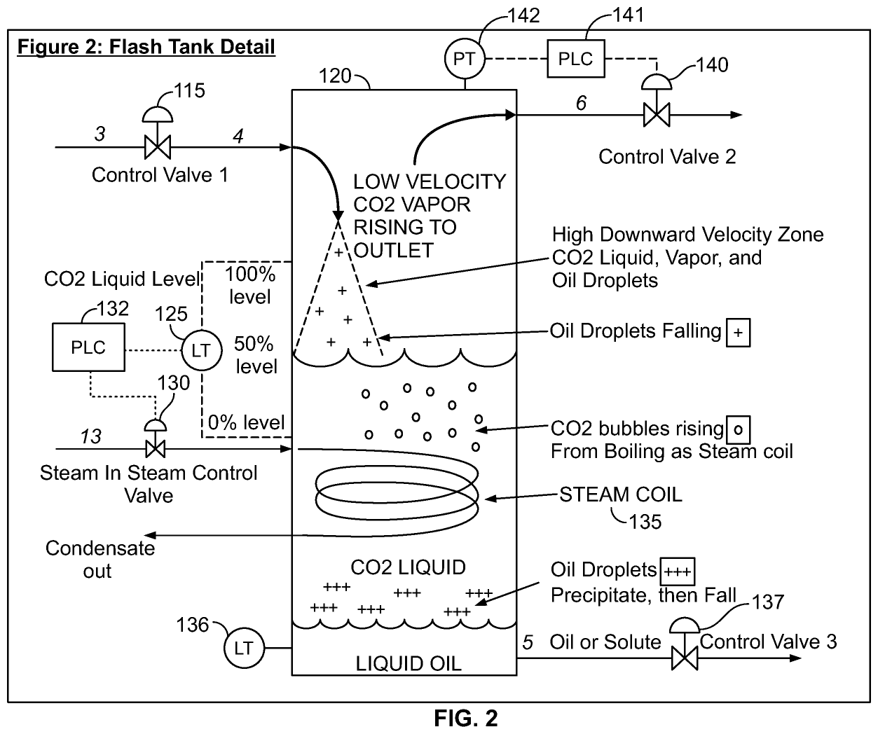

FIG. 2 illustrates in greater detail an embodiment of the present invention for use in extracting Cannabidiol (CBD), Tetrahydrocannabinol (THC), or both. FIG. 2 includes the first control valve 115, the first flash tank 120, the first tank level transmitter 125, the first tank steam control valve 130, the first tank steam coil 135, the first tank solute valve 137, and the second control valve 140 as shown in FIG. 1. Additionally, FIG. 2 includes a first tank oil level transmitter 136, a Programmable Logic Controller 132, a first flash tank pressure programmable logic controller 141, and a first flash tank pressure transmitter 142.

The extraction conditions are approximately the same for Hemp or Marijuana: 75-600 atmospheres, more preferably from 90-500 atmospheres, more preferably from 200 to 400 atmospheres, more preferably from 250-350 atmospheres and 10-105° C., more preferably between 30-60° C. The high pressure rich solvent stream of CO2 preferably has a concentration of dissolved oil in the range of 0.1 to 5%, whether the oil is CBD, THC, or a combination of the two. If Hemp strains are developed that have higher oil content than currently available, the CBD/THC concentration may increase above 5%. Hereafter, the term CBD will be used exclusively, although THC or CBD/THC combinations may be substituted. Additionally, embodiments of the present system may be used to extract other organic oils.

In operation, the flow rate of the high pressure rich solvent CO2 stream into the first flash tank 120 is controlled at first control valve 115, nominally at the same flow rate used for extraction. After the first control valve 115, the pressure in the medium pressure rich solvent stream 4 is below the critical point, and preferably in the range between 35 and 72.8 atmospheres. This range is chosen at above 35 atmospheres to stay above the freezing point of water, and below 72.8 atmospheres to stay below the critical point.

At the discharge side of the first control valve 115, the formerly supercritical CO2 cools to a temperature between 1° C. and 31° C., depending on the actual pressure selected. For instance, if the upstream side of the first control valve 115 were at 55 C and 300 atmospheres, and the pressure chosen for the first flash tank 120 is 60 atmospheres, the temperature drops to 23° C., the liquid/vapor saturation temperature, due to the auto-refrigeration properties of the CO2. At the same time, some of the CO2 becomes liquid, some vapor, in a ratio determined by the pressure selected. For instance, at 60 atmospheres, the vapor fraction is about 31%, the liquid fraction 69%, neglecting the negligible contribution of the CBD oil. The vapor fraction has a lower oil concentration, or may be virtually free of CBD oil. The liquid fraction may retain some dissolved CBD oil. Additionally, some portion of the CBD oil will be free droplets, flowing along with the liquid and vapor stream.

The inlet design of the first flash tank 120 includes a pipe or nozzle that is conventionally pointed down, in the direction that the heavier liquid phases are being directed to flow. The relatively High Downward Velocity Zone is shown in FIG. 2 as a dotted-line inverted “V.” In three-dimensional practice, it is roughly cone-shaped.

FIG. 2 shows the first flash tank 120 at equilibrium or steady-state conditions. The liquid CO2 and liquid CBD oil from the medium pressure rich solvent stream 4 are falling downward and into the mass of liquid shown in white in the center zone of the first flash tank 120.

In one embodiment of the present system: the amount of liquid CO2 entering in the medium pressure rich solvent stream 4 is boiled (vaporized) at the first tank steam coil 135 in the Liquid CO2 at the same or nearly the same rate it enters the first flash tank 120. The liquid level of the CO2 merely is maintained above the steam coils. In FIG. 2, the liquid level is shown controlled at 50%. However, any level between 10% and 90% may be adequate to maintain the level measurement and control the rate of steam.

At the equilibrium conditions shown above, CO2 vapor bubbles are continuously rising out of the Liquid CO2 and forming the majority of the CO2 Vapor rising at low velocity toward the outlet proximal to the second control valve 140. In the example cited above, 69% of the vapor is generated by the boiling at the steam coils.

At the same time the CO2 liquid is boiling, the CBD oil is precipitating out of solution. This happens because the CBD oil is entering at a constant or nearly constant rate, and the liquid CO2 eventually becomes saturated (reaches its solubility limit) with CBD oil. As additional CBD oil enters the flash tank, it cannot remain in solution, and precipitates out of solution, and drops by gravity through the less-dense CO2 liquid into the bottom of the first flash tank 120. There the CBD oil is maintained in a reservoir at a height sufficient to keep the outlet pipe covered and avoid any CO2 entrainment.

The first tank oil level transmitter 136 is used to detect the level of oil in the first flash tank 120 and is used to control the first tank solute valve 137 to modulate the solute fraction #1 stream 5 of CBD oil. The product CBD Oil stream may then be sent from the first tank solute valve 137 to another smaller flash tank to release minor quantities of dissolved CO2 to safely vent the gas, and from there to the final collection tank or a drum.

In one embodiment the present system includes the ability to maintain the concentration of the solute or CBD oil at saturation conditions in the flash tank. As additional CBD oil enters the flash tank, with no capacity to dissolve in the saturated CO2, that additional oil will remain discreet droplets, or displace other oil if there are concentration gradients, and precipitate and fall into the product stream.

The level control system for CO2 Liquid in the first flash tank 120 is depicted as using first tank level transmitter 125 employing differential pressure, where the pressure transmitters are calibrated for the overall system pressure and the difference caused by the heavier liquid on the bottom (0%) level transmitter. Any suitable level measurement may be deployed, a number of which are commercially available.

Similarly, first flash tank oil level transmitter 136 at the bottom of the first flash tank may also use any suitable commercially available level transmitter, although differential pressure would not be preferred for this application. This level transmitter and solute control valve are preferentially integrated with and operated by a PLC.

The first tank steam control valve 130 is used to control the rate of steam entering as stream 13. This steam rate controls the rate of CO2 boiling, and the steam flow is modulated using a PLC or Programmable Logic Controller 132 as shown in FIG. 2. This type of interface between a transmitter, in this case first tank level transmitter 125, and a control valve, in this case first tank steam control valve 130, may alternately be accomplished by other electronic or pneumatic systems.

For example, when the first tank level transmitter 125 may detect that the liquid level is rising and transmit that information to the programmable logic controller 132. The programmable logic controller 132 may be configured to then send a control signal to the first tank steam control valve 130 to reduce the flow rate of steam into the first tank steam coil 135. The reduction in the flow rate of steam then reduces the heating provided to the CO2 liquid, which in turn reduces the rate at which the CO2 is boiling, lowering the liquid level.

Later, when the first tank level transmitter 125 detects that the liquid level is falling, it may transmit that information to the programmable logic controller 132. The programmable logic controller 132 may be configured to then send a control signal to the first tank steam control valve 130 to increase the flow rate of steam into the first tank steam coil 135. The increase in the flow rate of steam then increases the heating provided to the CO2 liquid, which in turn increases the rate at which the CO2 is boiling, raising the liquid level.

The overall pressure in the first flash tank 120 is preferably controlled in the range previously stated between 35 and 72.8 atmospheres. That pressure is measured at first flash tank pressure transmitter 142 and controlled by modulating the second control valve 140 using a first flash tank pressure programmable logic controller 141 similar to that described above for the steam control system.

The same apparatus above may used to control higher or lower temperature and pressure flashing conditions, as in some cases it is desired to obtain different fractions of the oil. Some oil fractions will have varying degrees of solubility depending on the pressure in the first flash tank 120. A second flash tank 145 may be added as shown in FIG. 1 for this purpose, or even a third Flash Tank, similarly designed, but not shown. Additionally, the details and control systems shown in FIG. 2 for the first flash tank 120 may also be employed in the second flash tank 145 shown in FIG. 1 or in other flash tanks.

The precise process implementation of an embodiment of the present system may depend on exactly the type of Hemp Oil being extracted, and the desired for fractions or “Full-Spectrum” Oil, meaning all of the CBD components of Hemp. In any case, the selection of the optimal operating conditions follows the structures and process described above.

Thus, in one or more embodiments the present system provides a method for separating components from high pressure CO2. Additionally, as one aspect of the system, a heating medium is used to control the level in the flash tank.

One or more embodiments of the present system also provide the ability to maintain lower temperatures throughout the extraction/depressurization cycle than prior art which requires higher temperature before depressurization. Consequently, the present system may use less energy because heating all the rich gas to a sufficient temperature as in prior art requires 37 Kcal/kg, while vaporizing the liquid fraction in the flash tank requires only 22 Kcal/kg at 40 bars, and even less than 22Kcal/kg at 60 bars.

One or more embodiments of the present system may also use less energy because only part of the rich stream requires vaporizing. Thus, not only is the required energy less per kg as mentioned above, but less per kg/hr or unit of time. Combined, the typical application described here is less than half (only 46%) of the energy consumed by the prior art.

Additionally, one or more embodiments of the present system costs less to fabricate than prior art, owing to two factors: first, the heater coil described above may be designed for much lower pressure, e.g., 60 bar rating instead of the extraction condition rating upwards of 150 bar and more typically 300 bar. Lower pressure rating requires less wall thickness and less steel for fabrication.

An additional fabrication cost efficiency is provided by the system is that the heater coil would have the 60 bar rating on the outside of the heating medium pipes, compared to the inside of the pipes for the shell and tube exchanger required to heat the rich CO2 at elevated pressure in prior art applications. Since steel is substantially stronger in compression than in tension, this will further reduce the pipe wall thickness required, and reduce the steel costs for fabrication.

Although one or more embodiments have been illustrated above using CO2, other gasses and/or mixtures of gasses may be employed. For example, instead of CO2 alone, a high pressure dense gas blend of CO2 and other components such as a different gas may be employed

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A system for separating a solute from high pressure gas, said system including:
a flash tank receiving a medium pressure rich solvent stream of CO2, wherein droplets of said medium pressure rich solvent stream of CO2 fall downwardly in said flash tank and accumulate to form a solvent liquid having a liquid level;
a heating system disposed in said solvent liquid below said liquid level, wherein said heating system causes said solvent liquid to boil which causes solute to precipitate from said solvent liquid and fall downwardly in said flash tank;
a liquid level transmitter, wherein said liquid level transmitter detects said liquid level and controls said heating system to maintain a liquid level above said heating system; and
a solute valve allowing said solute to be extracted from a solute egress at the bottom of said flash tank.

2. The system of claim 1 wherein said wherein said heating system is a steam coil.

3. The system of claim 1 wherein said heating system is controlled by a programmable logic controller that receives said liquid level from said liquid level transmitter.

4. The system of claim 1 further including a control valve modulating a pressure stream exiting said flash tank.

5. The system of claim 4 further including a pressure transmitter measuring pressure in said flash tank.

6. The system of claim 5 further including a programmable logic controller receiving said pressure measurement from said pressure transmitter and controlling said control valve to maintain a desired pressure in said flash tank.

7. The system of claim 1 further including an oil level transmitter detecting a level of said solute in said flash tank.

8. The system of claim 7 wherein said solute valve is controlled based on said oil level.

9. The system of claim 1 wherein said solute is an organic oil.

10. The system of claim 1 wherein said solute is Cannabidiol (CBD).

11. The system of claim 1 wherein said solute is Tetrahydrocannabinol (THC).

12. The system of claim 1 wherein said solute is a mixture of CBD and THC.

13. The system of claim 1 wherein said medium pressure rich solvent stream of CO2 exits said flash tank and passes to a second flash tank, wherein droplets of said medium pressure rich solvent stream of CO2 fall downwardly in said second flash tank and accumulate to form a solvent liquid having a second flash tank liquid level;

14. The system of claim 13 wherein said second flash tank includes a second heating system disposed in said solvent liquid below said second flash tank liquid level, wherein said second heating system causes said solvent liquid to boil which causes solute to precipitate from said solvent liquid and fall downwardly in said second flash tank.

15. The system of claim 13 wherein said second flash tank includes a second liquid level transmitter, wherein said second liquid level transmitter detects said liquid level and controls said second heating system to maintain a desired liquid level.

16. The system of claim 13 wherein said second flash tank includes a second solute valve, wherein said second solute valve allows said solute to be extracted from a solute egress at the bottom of said second flash tank.

17. A method for separating a solute from high pressure CO2, said method including:
receiving a medium pressure rich solvent stream of CO2 in a flash tank, wherein droplets of said medium pressure rich solvent stream of CO2 fall downwardly in said flash tank and accumulate to form a solvent liquid having a liquid level;
heating said solvent liquid using a heating system disposed in said solvent liquid below said liquid level, wherein said heating causes said solvent liquid to boil which causes solute to precipitate from said solvent liquid and fall downwardly in said flash tank;
detecting said liquid level using a liquid level transmitter;
controlling said heating system based on said detected liquid level to maintain a liquid level above said heating system; and
extracting said solute from said flash tank through a solute egress controlled by a solute valve.
